(19) United States
(12) Patent Application Publication
(10) Pub. No.: US 2009/0295335 A1
(43) Pub. Date: Dec. 3, 2009

(54) BATTERY PACK AND CHARGING METHOD FOR THE SAME

(75) Inventors: Jongwoon Yang, Suwon-si (KR); Segawa Susumu, Suwon-si (KR); Sesub Sim, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/467,952

(22) Filed: May 18, 2009

(30) Foreign Application Priority Data
Jun. 3, 2008 (KR) 10-2008-0052277

(51) Int. Cl. H02J 7/00; H02J 7/04

(52) U.S. Cl. 320/134; 320/152

(57) ABSTRACT

A battery pack and charging method for the same are disclosed. The battery pack automatically regulates the full-charge voltage of a battery according to the temperature of the battery. The battery pack includes: a battery being rechargeable and having a positive electrode and negative electrode; a switching module having a charge switching device and discharge switching device electrically connected to a high-current path of the battery; and a battery management unit electrically connected to the switching module to control the charge switching device and discharge switching device, and changing a full-charge voltage of the battery according to temperature of the battery.

### CLAIM FOR PRIORITY

This application is based on and claims priority to Korean Patent Application No. 10-2008-0052277 filed on Jun. 3, 2008 in the Korean Intellectual Property Office (KIPO), the entire contents of which are hereby incorporated by reference.

### BACKGROUND OF THE INVENTION

1. Field of the Invention

The present invention relates to a battery pack and charging method for the same, and more particularly, to a battery pack and charging method for the same that automatically regulate the full-charge voltage of a battery according to the temperature of the battery.

2. Description of the Related Art

In a battery pack employing lithium-ion cells or lithium polymer cells, a safety circuit is electrically connected to a battery including an electrode assembly and electrolyte in a case. The battery is charged with electricity and discharges electricity through chemical reactions, and the safety circuit prevents overcharge and overdischarge of the battery by regulating the charge-discharge process to protect the battery.

A full-charge mode is provided to the safety circuit to prevent overcharge. At the full-charge mode, when the charge voltage of the battery reaches a preset value, the safety circuit automatically terminates charging of the battery.

In a battery pack with an integrated safety circuit, multiple battery cells can be connected in parallel, series or in both to provide sufficient power to a portable electronic product such as a laptop. The safety circuit manages the multiple battery cells as a single unit.

One of the battery cells in a battery pack may deteriorate in use or during the manufacturing process. A deteriorated cell may result in cell imbalance in the battery pack. A battery pack with cell imbalance has an open-circuit voltage greater than or less than that of a normal battery pack without cell imbalance.

When a deteriorated cell in a battery pack has a too-high open-circuit voltage, the safety circuit may permit charging until a preset full-charge voltage is reached. In this case, normal non-deteriorated cells in the battery pack experience the end of charging too early, and thus are not fully charged.

When a deteriorated cell in a battery pack has a too-low open-circuit voltage, the safety circuit may permit charging until a preset full-charge voltage is reached. In this case, non-deteriorated cells in the battery pack are continuously charged to the extent of overcharge, and thus are overheated. This condition may arise whenever battery charging is performed, lowering the safety of the battery pack.

The JEITA (Japan Electronics and Information Technology Industries Association) has attempted to solve the above problems, but have not yet proposed an adequate solution for battery packs manufactured separately from chargers.

### BRIEF SUMMARY OF THE INVENTION

The present invention has been made in view of the above problems, and the present invention provides a battery pack wherein the full-charge voltage of a battery is automatically regulated according to the temperature of the battery.

The present invention also provides a battery pack wherein the full-charge voltage of a battery with cell imbalance is automatically regulated during charging.

In accordance with an embodiment of the present invention, there is provided a battery pack including: a battery being rechargeable and having a positive electrode and negative electrode; a switching module having a charge switching device and discharge switching device electrically connected to a high-current path of the battery; and a battery management unit electrically connected to the switching module to control the charge switching device and discharge switching device, and changing a full-charge voltage of the battery according to temperature of the battery.

The battery may include a plurality of electrically connected battery cells.

The battery pack may further include a temperature sensor electrically connected to the battery management unit, and the battery management unit may detect the temperature of the battery using a signal read from the temperature sensor and lower the full-charge voltage of the battery when the detected temperature matches a threshold temperature.

The threshold temperature may be set to a temperature between 30 and 60 degrees Celsius, and a limit of lowering the full-charge voltage may be set to a voltage between 3.95V and 4.15V.

The battery management unit may turn off, upon detection of the full-charge voltage, the charge switching device to terminate charging of the battery.

The battery management unit may include: an analog front end electrically connected to the battery to detect a voltage of the battery, electrically connected to the switching module to turn on and off the switching module, and turning off the charge switching device upon detection of the full-charge voltage; and a microprocessor unit electrically connected to the analog front end, and adjusting a full-charge voltage for a full-charge mode in the analog front end.

The analog front end may detect an open-circuit voltage of the battery through an electrical connection, determine one of an over-discharge mode, full-discharge mode, full-charge mode and overcharge mode according to the voltage of the battery, and have a power driving circuit to turn on and off the charge switching device and discharge switching device according to the determined mode.

The charge switching device may include: a charging field-effect transistor (FET) electrically connected to the high-current path of the battery; and a parasitic diode associated with the charging FET, electrically connected in parallel to the charging FET, and connected in the reverse direction with respect to a charge current.

The discharge switching device may include: a discharging field-effect transistor (FET) electrically connected to the high-current path of the battery; and a parasitic diode associated with the discharging FET, electrically connected in parallel to the discharging FET, and connected in the reverse direction with respect to a discharge current.

In accordance with another embodiment of the present invention, there is provided a charging method for a battery pack, including: detecting temperature and voltage of a rechargeable battery; setting a full-charge voltage in consideration of the temperature through comparison of the detected temperature and voltage with a temperature/full-charge voltage table associating temperatures with full-charge voltages; and charging the battery until a charged voltage of the battery reaches the full-charge voltage set in consideration of the temperature, and terminating charging of the battery when the charged voltage of the battery matches the full-charge voltage.

The battery may include a plurality of electrically connected battery cells.

The temperature/full-charge voltage table may associate temperatures with full-charge voltages so that the full-charge voltage of the battery is gradually lowered as the temperature of the battery rises above a threshold temperature.

The threshold temperature for lowering the full-charge voltage may be set to a temperature between 30 and 60 degrees Celsius, and a limit of lowering the full-charge voltage may be set in a range between 3.95V and 4.15V.

Setting a full-charge voltage in consideration of the temperature may include checking whether the temperature of the battery is maintained for a preset time duration, and resetting the full-charge voltage with reference to the temperature/full-charge voltage table when the temperature of the battery is maintained for the time duration. The full-charge voltage may be reset with reference to the temperature/full-charge voltage table when the temperature of the battery is maintained for 1.5 to 4 seconds.

In a feature of the present invention, the full-charge voltage of a battery in a battery pack is automatically regulated according to the temperature of the battery, enhancing the safety of the battery pack.

In addition, the full-charge voltage of a battery with cell imbalance is automatically regulated during charging, further enhancing the safety of the battery pack.

The above-mentioned effect of the present invention has been briefly described to avoid obscuring the subject matter of the present invention, and will be described in more detail in the detailed description of the invention.

### BRIEF DESCRIPTION OF THE DRAWINGS

The features and advantages of the present invention will be more apparent from the following detailed description in conjunction with the accompanying drawings, in which:

FIG. 1 is a block diagram illustrating a battery pack according to an embodiment of the present invention;

FIG. 2 is a temperature/full-charge voltage table stored in a microprocessor unit of the battery pack of FIG. 1; and

FIG. 3 is a flow chart illustrating a charging method for the battery pack according to another embodiment of the present invention.

### DETAILED DESCRIPTION OF THE INVENTION

Hereinafter, embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring the subject matter of the present invention.

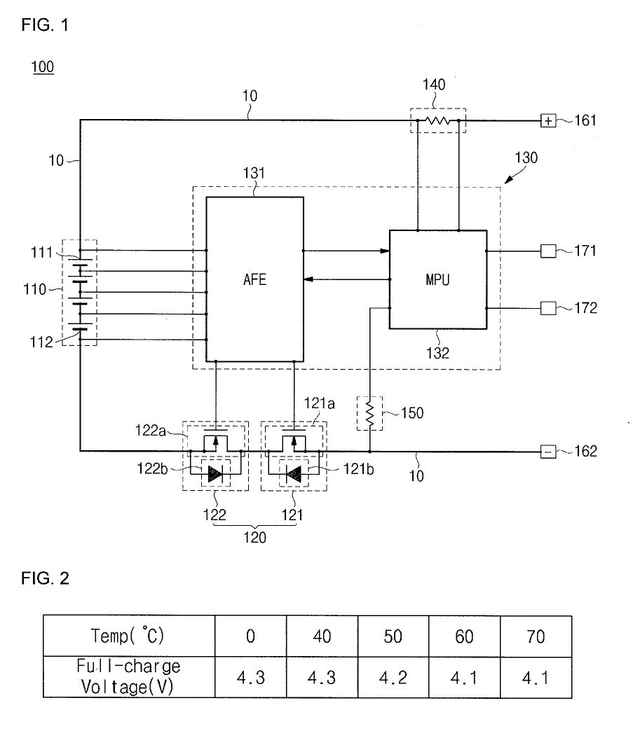

FIG. 1 is a block diagram illustrating a battery pack 100 according to an embodiment of the present invention.

Referring to FIG. 1, the battery pack 100 according to an embodiment of the present invention includes a battery 110, charge/discharge switching module 120, and battery management unit (BMU) 130. The battery pack 100 further includes a current detecting device 140. The battery pack 100 further includes a temperature sensor 150. The battery pack 100 further includes a positive terminal 161 and negative terminal 162 to electrically connect to a charger or an external load. The battery pack 100 further includes a first auxiliary terminal 171 and second auxiliary terminal 172 to communicate with an external entity.

The battery 110 includes rechargeable cells having a positive electrode 111 and negative electrode 112. The battery 110 is composed of lithium-ion cells or lithium polymer cells, and includes an electrode assembly and electrolyte in a case. The battery 110 may be composed of multiple cells as in FIG. 1, and may also be composed of a single cell.

The charge/discharge switching module 120 includes a charge switching device 121 and discharge switching device 122.

The charge switching device 121 includes a charging field-effect transistor (FET) 121a and a parasitic diode 121b associated with the charging FET 121a. Although the parasitic diode 121b, in one exemplary implementation, is an element necessarily formed through the fabricating process for the charging FET 121a, it is treated as a separate element for the purpose of description.

The drain and source of the charging FET 121a is installed on a high-current path 10 of the battery 110. The gate of the charging FET 121a is electrically connected to an analog front end (AFE) 131, and is turned on or off in response to a control signal from the AFE 131. When a charger (not shown) is connected to the positive terminal 161 and negative terminal 162, the charging FET 121a is turned on and conducts charging current from the charger to the battery 110.

The parasitic diode 121b is electrically connected in parallel to the charging FET 121a. The parasitic diode 121b is connected in the reverse direction with respect to a charge current. The parasitic diode 121b cuts off the path of charging current in case of full-charging of the battery 110. Accordingly, the parasitic diode 121b passes only the discharging current in case of full-charging of the battery 110 whereby the battery 110 is prevented from being over-charged, thereby enhancing the safety of the battery 110.

The discharge switching device 122 includes a discharging FET 122a and a parasitic diode 122b associated with the discharging FET 122a. Although the parasitic diode 122b, in one exemplary implementation, is an element necessarily formed through the fabricating process for the discharging FET 122a, it is treated as a separate element for the purpose of description.

The drain and source of the discharging FET 122a is installed on the high-current path 10 of the battery 110. The gate of the discharging FET 122a is electrically connected to the AFE 131, and is turned on or off in response to a control signal from the AFE 131. When the discharging FET 122a is turned on, it conducts discharging current of the battery 110 to an external load connected to the positive terminal 161 and negative terminal 162.

The parasitic diode 122b is electrically connected in parallel to the discharging FET 122a. The parasitic diode 122b is connected in the reverse direction with respect to a discharge current. The parasitic diode 122b cuts off the path of discharging current in case of full-discharging of the battery 110. Accordingly, the parasitic diode 122b passes only the charging current in case of full-discharging of the battery 110 whereby the battery 110 is prevented from being over-discharged, thereby enhancing the safety of the battery 110.

The BMU 130 includes an AFE 131 and microprocessor unit (MPU) 132.

The AFE 131 is electrically connected to a positive electrode 111 and negative electrode 112 of each cell of the battery 110. The AFE 131 is electrically connected to the gate of the charging FET 121a and to the gate of the discharging FET 122a. The AFE 131 detects a voltage difference between the positive electrode 111 and negative electrode 112 of the battery 110, sets one of modes including overdischarge, full-discharge, full-charge and overcharge for the battery 110, and turns on or off the charge/discharge switching module 120 according to the set mode. Thereto, the AFE 131 includes a power driving circuit to control the charge/discharge switching module 120.

In the modes including overdischarge, full-discharge, full-charge and overcharge, the overdischarge mode is set when the voltage of the battery 110 falls below 1.0V. In the overdischarge mode, the AFE 131 automatically switches off and stops discharging of the battery 110 so as not to consume power. Thereafter, in response to a charging signal from a charger (not shown) after the charger is connected between the positive terminal 161 and negative terminal 162, the AFE 131 transitions to the full-discharge mode. The full-discharge mode is set when the voltage of the battery 110 falls to about 1.0V. In the full-discharge mode, the AFE 131 turns on the charge switching device 121, and turns off the discharge switching device 122 to cut off the current to an external load before overdischarging of the battery 110. The full-charge mode is set when the voltage of the battery 110 is about 4.3V. In the full-charge mode, the AFE 131 turns off the charge switching device 121 so as not to overcharge the battery 110, preventing overheating of the battery 110. The overcharge mode is set when the voltage of the battery 110 is higher than 4.3V. In the overcharge mode, the AFE 131 turns off the charge switching device 121 to stop charging of the battery 110.

The AFE 131 is an application specific integrated circuit (ASIC) acting as a power-driving circuit device to instantly detect the voltage of the battery 110 and drive the charge/discharge switching module 120. That is, the AFE 131 rapidly turns on and off the charge/discharge switching module 120 according to the mode to protect the battery 110 directly.

The MPU 132 includes a microprocessor (not shown), and a passive element (not shown), active element (not shown), and memory element (not shown) that are electrically connected to the microprocessor. The MPU 132 is electrically connected to the AFE 131, and receives voltage information about the battery 110. The MPU 132 may change voltage levels set in the AFE 131 for the overdischarge mode, full-discharge mode, full-charge mode and overcharge mode. The MPU 132 may output a control signal to the AFE 131 to turn on or off the charge/discharge switching module 120. The MPU 132 measures the amount of current during charging or discharging of the battery 110. Thereto, the MPU 132 is electrically connected to the two ends of the current detecting device 140, and measures the change in voltage difference between the ends of the current detecting device 140 and calculates the amount of current. In addition, the MPU 132 measures the temperature of the battery 110. Thereto, the MPU 132 is electrically connected to the temperature sensor 150, and detects the temperature of the battery 110.

The temperature sensor 150 is electrically connected between the MPU 132 and the high-current path 10 of the battery 110. In the present embodiment, the temperature sensor 150 is made of a thermistor, and the MPU 132 detects the temperature of the battery 110 by measuring the change in resistance of the thermistor.

Referring to FIG. 2, which illustrates a temperature/full-charge voltage table recording full-charge voltages matched with battery temperatures. The MPU 132 stores a temperature/full-charge voltage table relating full-charge voltages to battery temperatures as illustrated in FIG. 2. The MPU 132 obtains temperature information of the battery 110 by converting an electrical value read from the temperature sensor 150 into a battery temperature. Referring to the temperature/full-charge voltage table, when the temperature of the battery 110 is about 40 degrees Celsius (lower threshold temperature for full-charge voltage regulation), the full-charge voltage is maintained at 4.3V without change. When the temperature of the battery 110 is about 50 degrees Celsius, the full-charge voltage is set to 4.2V with a decrement of about 0.1V. When the temperature of the battery 110 is between about 67 and 70 degrees Celsius, the full-charge voltage is set to 4.1V. Accordingly, the MPU 132 regulates the full-charge voltage of the battery 110 according to the battery temperature, prevents overheating of the battery 110, and thus enhances the safety of the battery 110.

In the temperature/full-charge voltage table of the FIG. 2, the full-charge voltage is lowered in a temperature range of 40 to 60 degrees Celsius. Preferably, the lower threshold temperature for lowering the full-charge voltage is set to a temperature between 30 and 60 degrees Celsius. For a battery pack used in a low-temperature region, the lower threshold temperature may be set to 30 degrees Celsius. For a battery pack used in a high-temperature region, the lower threshold temperature may be set to 60 degrees Celsius. For a battery pack employed in a portable electronic device, the lower threshold temperature can be set to a temperature between 30 and 60 degrees Celsius in consideration of purpose, environment, amount of power, and safety.

The limit of lowering the full-charge voltage may be regulated in a range between 3.95V and 4.15V. This is because charging efficiency can be lowered if the full-charge voltage is set too low. That is, the limit of lowering the full-charge voltage is set to a value that is greater than or equal to 3.95V for charging efficiency and is less than 4.15V for battery safety.

The current detecting device 140 is installed on the high-current path 10 of the battery 110. The two ends of the current detecting device 140 are electrically connected to the MPU 132. In the present embodiment, the current detecting device 140 is made of a sense resistor. The MPU 132 measures the voltage difference between two ends of the sense resistor, and calculates the change in voltage difference therebetween. The MPU 132 measures the voltage difference between the two ends of the sense resistor after storing a preset reference voltage of the sense resistor, and converts a change in voltage difference into a current value. Thereafter, the MPU 132 computes the charge rate of the battery 110 by accumulating obtained current values. The MPU 132 can compute the amount of current during charging or discharging of the battery 110, and thus can turn off the charge/discharge switching module 120 to prevent deterioration and malfunction of the battery 110 due to overcurrent.

Next, driving of the battery pack for battery charging is described.

When a charger (not shown) is brought into contact with the positive terminal 161 and negative terminal 162, the charge switching device 121 is turned on in response to a control signal from the AFE 131 and conducts charging current to the battery 110. Hence, the battery 110 is charged. At this time, the full-charge voltage set at the AFE 131 is 4.3V. That is, when the open-circuit voltage between the positive electrode 111 and negative electrode 112 of the battery 110 approaches 4.3V after continuous charging, the AFE 131 outputs a control signal to turn off the charge switching device 121. Hence, charging of the battery 110 is stopped, inhibiting overheating.

In addition, the end-of-charge time may be changed according to a change in temperature during the charge process. To be more specific, during charging of the battery 110, the MPU 132 measures the resistance of the thermistor of the temperature sensor 150 and calculates the current temperature of the battery 110 using the measured resistance. The MPU 132 refers to the stored temperature/full-charge voltage table mapping temperatures to full-charge voltages. Referring to the temperature/full-charge voltage table of FIG. 2, the AFE 131 maintains the full-charge voltage at 4.3V while the temperature of the battery 110 is between 0 and 40 degrees Celsius. When the temperature of the battery 110 reaches 50 degrees Celsius, the MPU 132 sends a control signal to the AFE 131 to lower the full-charge voltage to 4.2V. Hence, if the battery 110 is being charged at 50 degrees Celsius, the full-charge voltage is lowered and the end-of-charge time is advanced. If the battery 110 is being charged at a temperature higher than or equal to 50 degrees Celsius, the full-charge voltage is lowered further and the end-of-charge time is advanced further. As a result, overheating of the battery 110 is prevented and safety is enhanced. In the case when a cell of the battery 110 deteriorates (i.e., cell imbalance occurs in the battery 110), even though the battery cells receive the same amount of charge current, they provide different open-circuit voltages. In this case also, changing the full-charge voltage according to the temperature of the battery 110 enhances the safety of the battery 110.

As described above, lowering the full-charge voltage of the battery 110 according to the rising temperature thereof enhances the safety of the battery pack 100.

In the case when cell imbalance involving plural battery cells occurs in the battery pack 100, the full-charge voltage is changed according to the temperature of the battery 110, and thus charging of the battery 110 can be performed normally.

To be more specific, when one of the cells in the battery 110 deteriorates (i.e., cell imbalance occurs in the battery 110), the mean voltage of the battery 110 lowers. Non-deteriorated cells of the battery 110 deliver open-circuit voltages higher than or equal to the mean voltage. If the battery 110 were charged at a normal voltage of 4.3V, the non-deteriorated cells would be overheated and be in a dangerous state. In the battery pack 100 of the present embodiment, when the temperature of the battery 110 employing plural cells rises above the lower threshold temperature, the full-charge voltage is gradually lowered, preventing overheating of the battery 110 and enhancing safety.

Next, a charging method for the battery pack 100 is described.

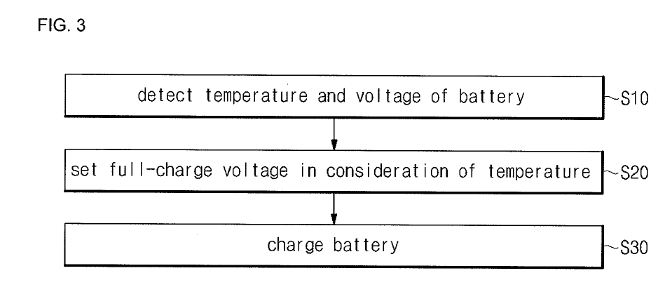

FIG. 3 is a flow chart illustrating a charging method for a battery pack according to another embodiment of the present invention.

Referring to FIG. 3, the charging method for a battery pack includes steps of detecting temperature and voltage (S10), setting a temperature-related full-charge voltage (S20), and battery charging (S30). In the following description, the battery pack 100 depicted in FIGS. 1 and 2 is referred to, but a repeated description is omitted of the battery pack 100 in relation to a configuration, function, process, and numeric range.

At step S10 of detecting temperature and voltage, the AFE 131 detects the open-circuit voltage of the battery 1 10, and the MPU 132 calculates the temperature of the battery 110.

At step S20 of setting a temperature-related full-charge voltage, the MPU 132 searches the stored temperature/full-charge voltage table associating temperatures with full-charge voltages for a full-charge voltage matching the calculated temperature, and sets the full-charge voltage of the battery 110 according to the temperature thereof.

In the temperature/full-charge voltage table of the FIG. 2, the full-charge voltage is lowered to 4.1V. However, as described previously, the limit of lowering the full-charge voltage may be set in a range between 3.95V and 4.15V. The lower threshold temperature for lowering the full-charge voltage may be set to a temperature between 30 and 60 degrees Celsius.

In addition, at step S20, the MPU 132 checks whether the temperature of the battery 110 is maintained for a preset time duration, and resets, if the temperature of the battery 110 is maintained for the time duration, the full-charge voltage according to the temperature. For example, when the full-charge voltage is set to 4.2V and the temperature of the battery 110 is 70 degrees Celsius, the MPU 132 changes the full-charge voltage to 4.1V after expiration of a time duration of 1.5 to 4 seconds. This is to prevent an abrupt change in full-charge voltage of the battery 110 due to a momentary rise in temperature of the battery 110.

At step S30 of battery charging, the battery 110 is charged until the full-charge voltage set at step S20 in relation to the temperature is reached. In other words, when the open-circuit voltage of the battery 110 becomes higher than or equal to the set full-charge voltage through charging, charging of the battery 110 is terminated.

As described above, the charging method for a battery pack 100 lowers the full-charge voltage of a battery 110 according to the temperature of the battery 110, and thus further enhances the safety of the battery pack 100.

Even though cell imbalance involving plural battery cells occurs in a battery pack, the charging method changes the full-charge voltage according to the battery temperature, and thus enables normal charging of the battery 110.

Although the embodiments of the present invention have been described in detail hereinabove, it should be understood that many variations and modifications of the basic inventive concept herein described will still fall within the spirit and scope of the present invention as defined in the appended claims.

What is claimed is:

1. A battery pack comprising:
a battery being rechargeable and having a positive electrode and negative electrode;
a switching module having a charge switching device and discharge switching device electrically connected to a high-current path of the battery; and
a battery management unit electrically connected to the switching module to control the charge switching device and discharge switching device, and changing a full-charge voltage of the battery according to temperature of the battery.

2. The battery pack of claim 1, wherein the battery comprises a plurality of electrically connected battery cells.

3. The battery pack of claim 1, further comprising a temperature sensor electrically connected to the battery management unit, and wherein the battery management unit detects the temperature of the battery using a signal read from the temperature sensor and lowers the full-charge voltage of the battery when the detected temperature matches a threshold temperature.

4. The battery pack of claim 3, wherein the threshold temperature is set to a temperature between 30 and 60 degrees Celsius.

5. The battery pack of claim 4, wherein a limit of lowering the full-charge voltage is set to a voltage between 3.95V and 4.15V.

6. The battery pack of claim 1, wherein the battery management unit turns off, upon detection of the full-charge voltage, the charge switching device to terminate charging of the battery.

7. The battery pack of claim 1, wherein the battery management unit comprises:
an analog front end electrically connected to the battery to detect a voltage of the battery, electrically connected to the switching module to turn on and off the switching module, and turning off the charge switching device upon detection of the full-charge voltage; and
a microprocessor unit electrically connected to the analog front end, and adjusting a full-charge voltage for a full-charge mode in the analog front end.

8. The battery pack of claim 7, wherein the analog front end detects an open-circuit voltage of the battery through an electrical connection, determines one of an overdischarge mode, full-discharge mode, full-charge mode and overcharge mode according to the voltage of the battery, and has a power driving circuit to turn on and off the charge switching device and discharge switching device according to the determined mode.

9. The battery pack of claim 1, wherein the charge switching device comprises:
a charging field-effect transistor (FET) electrically connected to the high-current path of the battery; and
a parasitic diode associated with the charging FET, electrically connected in parallel to the charging FET, and connected in the reverse direction with respect to a charge current.

10. The battery pack of claim 1, wherein the discharge switching device comprises:
a discharging field-effect transistor (FET) electrically connected to the high-current path of the battery; and
a parasitic diode associated with the discharging FET, electrically connected in parallel to the discharging FET, and connected in the reverse direction with respect to a discharge current.

11. A charging method for a battery pack, comprising:
detecting temperature and voltage of a rechargeable battery;
setting a full-charge voltage in consideration of the temperature through comparison of the detected temperature and voltage with a temperature/full-charge voltage table associating temperatures with full-charge voltages; and
charging the battery until a charged voltage of the battery reaches the full-charge voltage set in consideration of the temperature, and terminating charging of the battery when the charged voltage of the battery matches the full-charge voltage.

12. The charging method of claim 11, wherein the battery comprises a plurality of electrically connected battery cells.

13. The charging method of claim 11, wherein the temperature/full-charge voltage table associates temperatures with full-charge voltages so that the full-charge voltage of the battery is gradually lowered as the temperature of the battery rises above a threshold temperature.

14. The charging method of claim 13, wherein the threshold temperature for lowering the full-charge voltage is set to a temperature between 30 and 60 degrees Celsius.

15. The charging method of claim 14, wherein a limit of lowering the full-charge voltage is set in a range between 3.95V and 4.15V.

16. The charging method of claim 11, wherein setting a full-charge voltage in consideration of the temperature comprises checking whether the temperature of the battery is maintained for a preset time duration, and resetting the full-charge voltage with reference to the temperature/full-charge voltage table when the temperature of the battery is maintained for the time duration.

17. The charging method of claim 16, wherein the full-charge voltage is reset with reference to the temperature/full-charge voltage table when the temperature of the battery is maintained for 1.5 to 4 seconds.

18. A battery assembly comprising:
at least one rechargeable battery having a positive electrode and a negative electrode wherein the positive electrode and the negative electrode define a high current path that is adapted to be electrically coupled to a charging circuit and to a load;
a battery management unit that controls the level of charge of the at least one rechargeable battery and charges the at least one rechargeable battery to a full-charge value wherein the battery management unit monitors the temperature of the at least one rechargeable battery and adjusts the full-charge value based upon the monitored temperature of the battery.

19. The assembly of claim 18, further comprising a temperature sensor that senses the temperature along the high current path to provide an indication to the battery management unit of the temperature of the at least one rechargeable battery.

20. The assembly of claim 18, wherein the battery management unit includes a stored range of temperatures and an associated stored range of full-charge values and wherein the battery management unit, when controlling the charging of the at least one rechargeable battery, determines a full-charge value by selecting the full-charge value that corresponds to the monitored temperature.

21. The assembly of claim 20 wherein the stored range of monitored temperature comprises between 0 and 40 C, between 41 and 59 C and between 60 and 80 C and the corresponding full-charge value comprises 4.3V, 4.2V and 4.1V.

22. The assembly of claim 20 further comprising a switching module having a charge switching device and a discharge switching device electrically connected to the high-current path of the battery and wherein the battery management unit controls the charge switching device and the discharge switching device to control the battery.

23. The assembly of claim 22, wherein the battery management unit detects an open-circuit voltage of the battery through an electrical connection, determines one of an overdischarge mode, a full-discharge mode, full-charge mode and overcharge mode according to the voltage of the battery controls the operation of the charge switching device and discharge switching device based upon the mode.
